(19) United States
(12) Patent Application Publication
(10) Pub. No.: US 2006/0146513 A1
(43) Pub. Date: Jul. 6, 2006

(54) Innovated type of luminescent cover unit for lighting unit

(76) Inventor: Mei Lan Yu Liu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/024,427

(22) Filed: Dec. 30, 2004

(51) Int. Cl. F21K 2/00

(52) U.S. Cl. 362/34

(57) ABSTRACT

An innovated type of luminescent cover unit for lighting unit, applicable to a variety of lighting fixtures (such as a lamp tube or a light bulb), made of flexible, elastic, environmentally-friendly, see-through materials, in combination with long-lasting luminescent materials in the shape of a cylinder, a C figure or a bag that is either colored and translucent or uncolored and transparent. The cover unit envelops or wraps the lighting unit for regular lighting purposes at normal hours; the cover unit made to have a colored and translucent surface functions to change the color of light projected from the lighting unit to create a different atmosphere; the cover unit continuously absorbs and stores the luminous energy projected by the lighting unit at normal hours, and give luminescent light during nighttime or in case of power failure, thereby achieving the purposes of free change of use and cost savings.

### FIELD OF THE INVENTION

The present invention relates to an innovated type of luminescent cover unit applicable to a variety of lighting fixtures (such as a lamp tubes, a light bulb, etc.), made of flexible, elastic, environmentally-friendly, see-through materials, in combination with long-lasting luminescent materials, in the shape of a cylinder, a C-shape tube, or a bag that is either colored and translucent or uncolored and transparent. The cover unit is used to wrap or envelop a lamp unit for daily lighting purposes. A colored translucent cover unit serves to change the color of the light source projected from a lamp unit to create different atmospheres. The luminous energy projected from a regular lamp unit can be continuously absorbed by and stored in the cover unit, so that at night or in case of a power failure, the cover unit can be used to give luminescence. It has the double advantage of an optional change of alternative use and cost savings. Particularly, it can be used for lighting purposes in all occasions, achieving performances of lighting at night, lighting for public and safety facilities, and luminescent light indication in case of power failure.

### DESCRIPTION OF THE PRIOR ART

The conventional lamp unit (such as a lamp tube or a light bulb) uses electric power to give light. At home, in public places or safety facilities, we use lamp units to light the space. The light projected from the lamp unit is either fluorescent or incandescent. High costs must be paid for lamp units that give other colors of light for special occasions and atmospheres. However, all lamp units are powered by electric energy. In the middle of the night, lighting in a residence is only for contingent use, which could mean a waste of electrical energy. In case of power failure when the regular lamp unit can not give light, people have to light a candle or a flashlight for lighting purposes, which is quite inconvenient. In case of power failure at a public location, people can easily panic and result in accidents.

To seek improvement on the above shortcomings, the inventor has come up with the present invention that could give light even when a regular lamp unit fails in case of power failure, to achieve the objectives of safety, saving on energy, changing the color of light from a regular lamp unit, and creating a special atmosphere.

For a better understanding of the construction, objectives, approach and spirit of the present invention, please refer to the following description and drawings.

### BRIEF DESCRIPTION OF THE DRAWINGS

FIG. 1 is a schematic view of the invention of a cylinder unit and C-shape tube unit in combination with a lamp tube.

FIG. 2 is a side view of the invention of a cylinder unit in combination with a lamp tube in their luminous state.

FIG. 3 is a side view of the invention of C-shape tube unit in combination with a lamp tube in their luminous state.

FIG. 4 is a schematic view of the invention of a bag unit in combination with a light bulb.

FIG. 5 is a schematic view of the invention of bag unit in combination with a light bulb in their luminous state.

### DESCRIPTION OF THE PREFERRED EMBODIMENT

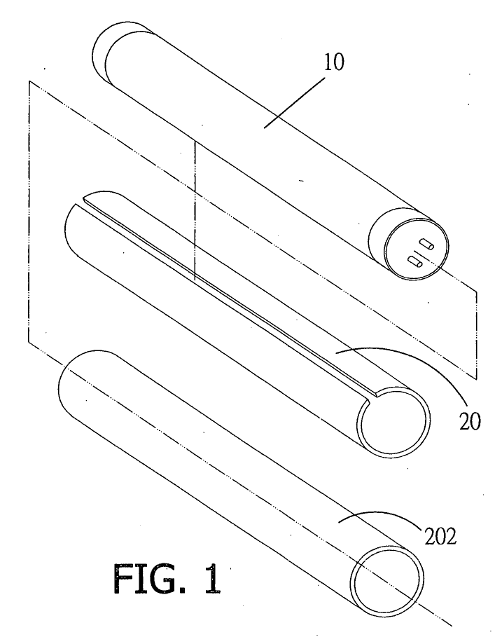

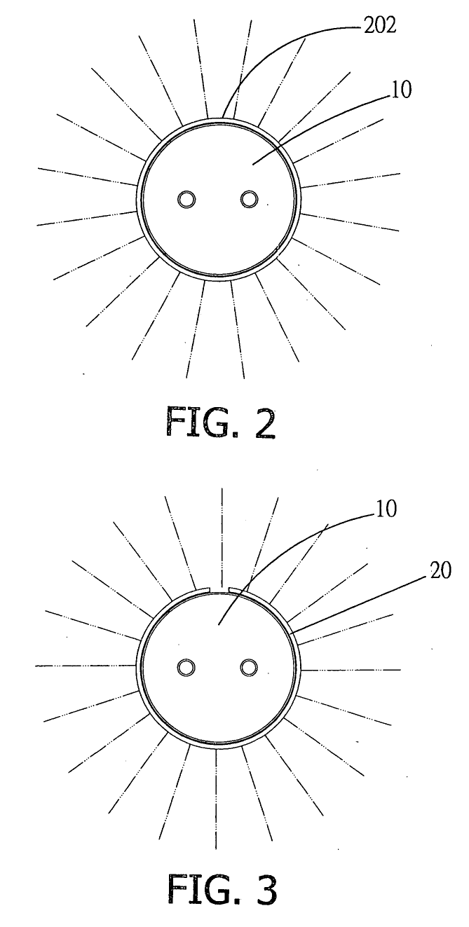

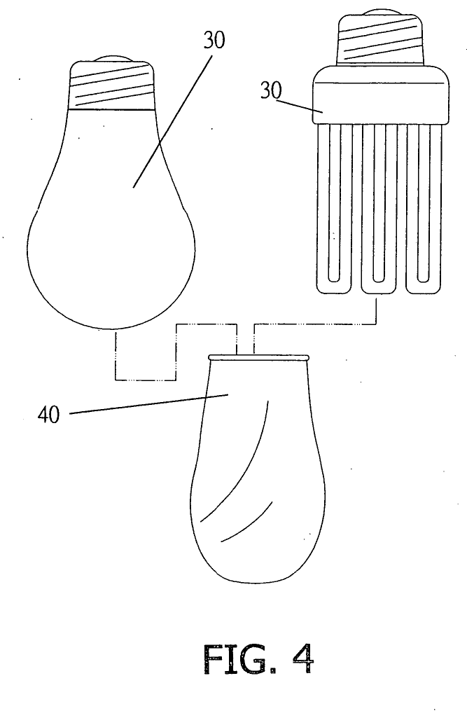

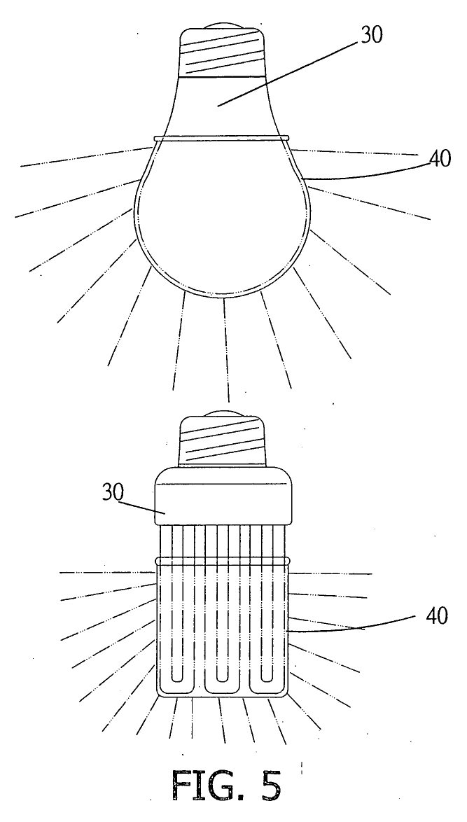

The present invention relates to an innovated type of luminescent cover unit for a lamp unit, which is applicable to a variety of lighting fixtures, such as a lamp tube 10, or a light bulb 30. Using flexible, elastic, environmentally-friendly, see-through materials, and in combination with long-lasting luminescent materials, the invention is made in the shape of a cylinder-shape cover unit 202, a C-shape cover unit 20 (as shown in FIG. 1), or a bag-shape cover unit 40 (shown in FIG. 4) that is either colored and translucent or uncolored and transparent. The cylinder-shape cover unit 202 or the C-shape cover unit 20 is used to wrap or envelop a lamp tube 10 (FIGS. 1, 2 and 3). The bag-shape cover unit 40 is used to wrap a light bulb 30 (FIGS. 4 and 5).

In normal hours, the lamp unit is used for regular lighting. When the cover unit 20, 202, 40 is made to have a colored and translucent surface, it changes the color of the light source projected from the lamp unit 10, 30 to create a different atmosphere. When the cover unit 20, 202, 40 is made to have a non-colored and transparent surface, it will not change the color of light projected from the lamp unit 10, 30. Besides, the luminous energy projected from a lamp unit in regular hours can be continuously absorbed by and stored in the cover unit 20, 202, 40, and, at nighttime or in case of power failure, the cover unit 20, 202, 40 will give luminescent light; thereby achieving the purpose of saving energy. It has the double advantage of optional change of alternative use and cost savings. Particularly, it can be used for lighting purposes in all occasions, achieving performances of lighting at night, lighting for public and safety facilities, and luminescent light indication in case of power failure.

The present invention of a luminescent cover unit for lighting fixtures is capable of achieving the anticipated performance, and is not yet used in public. Having satisfied the requirements for applicability and novelty for a patent right, this application is filed. Your favorable consideration will be appreciated.

It is to be understood that the above description of preferred embodiments made for the purpose of explanation should not be based to restrict the scope of the present invention, and that all modifications and variations made without departing from the spirit of the description and drawings should be included in the subject claim.

What the invention claimed is:

1. An innovated type of luminescent cover unit for lighting unit, applicable to a variety of lighting units, including a lamp tube and a light bulb, made of flexible, elastic, environmentally-friendly, and see-through materials, in combination with long-lasting luminescent materials, in a cylinder shape cover unit, a C-shape cover unit or a bag-shape cover unit, optionally colored and translucent and uncolored and transparent, the cover unit made in either one of a cylinder shape and a C shape being used to wrap or envelop a lamp tube, the cover unit made in a bag shape being used to wrap a light bulb.

2. The innovated type of luminescent cover unit for lighting unit of claim 1, wherein, the cover unit made in one of cylinder shape, C shape and bag shape, is used for regular lighting purposes of the lighting unit; the cover unit made in a form of a colored and translucent cover unit serving to change a color of light projected from the lighting unit to create a different atmosphere, while the cover unit made in a form of an uncolored and transparent cover unit does not change a color of light projected from the lighting unit.

3. The innovated type of luminescent cover unit for lighting unit of claim 1, wherein, the cover unit made in either a cylinder shape, C shape and bag shape continuously absorbs and stores luminous energy projected by the lighting unit in normal hours, and gives luminescent light during nighttime and in case of power failure, thereby saving power energy.
